(19) United States
(12) Patent Application Publication
(10) Pub. No.: US 2011/0102382 A1
(43) Pub. Date: May 5, 2011

(54) Rotational Input Device and Electronic Apparatus

(75) Inventor: Noriyuki SHIMIZU, Daito-shi (JP)

(73) Assignee: Funai Electric Co., Ltd., Daito-shi (JP)

(21) Appl. No.: 12/938,731

(22) Filed: Nov. 3, 2010

(30) Foreign Application Priority Data
Nov. 4, 2009 (JP) 2009-252693

(51) Int. Cl. G09G 5/00

(52) U.S. Cl. 345/184

(57) ABSTRACT

This rotational input device is so formed that, when a rotational position detecting portion detects that a user has at least rotationally operated a rotational operating portion, a magnetic force generating portion is excited on the basis of a detected rotational position to generate magnetic force so that a base portion is sucked toward the rotational operating portion to be so deflected as to come into contact with the rotational operating portion thereby providing the user with a tactile sensation.

### BACKGROUND OF THE INVENTION

1. Field of the Invention

The present invention relates to a rotational input device and an electronic apparatus, and more particularly, it relates to a rotational input device and an electronic apparatus each including a rotational operating portion and a base portion.

2. Description of the Background Art

A rotational input device and an electronic apparatus each including a rotational operating portion and a base portion are known in general, as disclosed in each of Japanese Utility Model Registration No. 3075129, Japanese Patent Laying-Open No. 2008-16426, Japanese Patent No. 3049072 and Japanese Patent Laying-Open No. 2006-19046, for example.

The aforementioned Japanese Utility Model Registration No. 3075129 discloses a rotary switch (rotational input device) including a circular positioner (base portion), a cylindrical sliding guide groove, provided on a central portion of the positioner, having a plurality of projecting portions formed on the outer peripheral portion thereof, a wiry elastic body provided with projecting portions whose central portions are bent to fit into grooves between the projecting portions of the sliding guide groove and a control board (rotational operating portion), mounted with the elastic body, relatively rotationally operable with respect to the positioner. In the rotary switch described in the aforementioned Japanese Utility Model Registration No. 3075129, the surfaces of the projecting portions of the elastic body mounted on the control board and those of the projecting portions of the sliding guide groove or the grooves between the projecting portions are in contact with each other. The rotary switch is so formed that the elastic body moves with the control board and the projecting portions of the elastic body move (shift) along the grooves between the adjacent projecting portions of the sliding guide groove when the user rotationally operates the control board. Further, the rotary switch is formed to provide the user's hand operating the control board with an operational sensation (tactile sensation) at this time due to mechanical resistance resulting from the movement of the projecting portions of the elastic body.

The aforementioned Japanese Patent Laying-Open No. 2008-16426 discloses a switch device including a cylindrical switch case, a switch operating shaft (rotational operating portion) provided through a through-hole formed on a lid body of the switch case, a discoidal driven plate (base portion), connected to the lower end portion of the switch operating shaft, having a plurality of grooves formed on the surface closer to the lid body, a base plate provided on the surface of the lid body of the switch case closer to the driven plate and columnar detent pieces provided on the base plate and formed to fit into the grooves provided on the driven plate. In the switch device described in the aforementioned Japanese Patent Laying-Open No. 2008-16426, the surfaces of the detent pieces and those of the grooves of the driven plate are regularly in contact with each other. The detent pieces are formed to be urged toward the grooves of the driven plate by springs provided in the base plate. When the user rotationally operates the switch operating shaft, the detent pieces fitting in the grooves of the driven plate move into the adjacent grooves over crests between the grooves of the driven plate against the urging force of the springs. The switch device is formed to provide the user's hand operating the switch operating shaft with a tactile sensation at this time due to mechanical resistance resulting from the urging force of the springs.

The aforementioned Japanese Patent No. 3049072 discloses a rotational electrical component (rotational input device) including an inner rotor (rotational operating portion) having a flange portion, a plurality of magnets circularly provided on the surface of the flange portion of the inner rotor at prescribed intervals and a spacer (base portion), consisting of a magnetic metal plate, arranged to be opposed to the magnets and provided with a plurality of openings. In the rotational electrical component described in the aforementioned Japanese Patent No. 3049072, the spacer is regularly sucked toward the magnets by magnetic force. The rotational electrical component is so formed that the magnets rotate with the inner rotor when the user rotationally operates the inner rotor. When the user rotates the inner rotor, the magnets are going to move to stick to the spacer while avoiding the openings of the spacer. At this time, the rotational electrical component provides the user's hand operating the inner rotor with a click sensation (tactile sensation) due to resistance resulting from the magnetic force.

The aforementioned Japanese Patent Laying-Open No. 2006-19046 discloses a rotational electrical component (rotational input device) including a rotational member (rotational operating portion) having a rotating shaft, a discoidal click plate arranged to overlap with the rotational member in plan view and provided with a plurality of concavo-convex click cams and a plate spring (base portion) arranged to overlap with the click plate in plan view and provided with click protrusions formed to fit into the click cams. In the rotational electrical component described in the aforementioned Japanese Patent Laying-Open No. 2006-19046, the surfaces of the click cams formed on the click plate and those of the click protrusions formed on the plate spring are regularly in contact with each other. The rotational electrical component is so formed that the click plate rotates with the rotational member when the user rotationally operates the rotating shaft of the rotational member. Further, the rotational electrical component is so formed that recess portions and projecting portions of the click cams formed on the click plate alternately slide with respect to the click protrusions formed of the plate spring at this time thereby providing the user with a tactile sensation due to mechanical sliding resistance.

In the rotary switch according to the aforementioned Japanese Utility Model Registration No. 3075129, however, the surfaces of the projecting portions of the elastic body mounted on the control board and those of the projecting portions of the sliding guide groove or the grooves between the projecting portions are regularly in contact with each other, and hence rotational resistance is disadvantageously caused between the surfaces of the projecting portions of the elastic body mounted on the control board and those of the projecting portions of the sliding guide groove or the grooves between the projecting portions when the user rotationally operates the control board. Even if force (tactile sensation) for stopping the rotation acts in the state having the rotational resistance, therefore, the tactile sensation may be hard to transmit to the user. In other words, it may be difficult for the user to obtain the tactile sensation.

In the switch device according to the aforementioned Japanese Patent Laying-Open No. 2008-16426, the surfaces of the detent pieces and those of the grooves of the driven plate are regularly in contact with each other, and hence rotational resistance is disadvantageously caused between the surfaces of the detent pieces and those of the grooves of the driven plate when the user rotationally operates the switch operating shaft. Even if force (tactile sensation) for stopping the rotation acts in the state having the rotational resistance, therefore, the tactile sensation may be hard to transmit to the user. In other words, it may be difficult for the user to obtain the tactile sensation.

In the rotational electrical component according to the aforementioned Japanese Patent No. 3049072, the spacer is regularly sucked toward the magnets by magnetic force, and hence rotational resistance is disadvantageously caused when the user rotationally operates the inner rotor. Even if force (tactile sensation) for stopping the rotation acts in the state having the rotational resistance, therefore, the tactile sensation may be hard to transmit to the user. In other words, it may be difficult for the user to obtain the tactile sensation.

In the rotational electrical component according to the aforementioned Japanese Patent Laying-Open No. 2006-19046, the surfaces of the click cams formed on the click plate and those of the click protrusions formed on the plate spring are regularly in contact with each other, and hence rotational resistance is disadvantageously caused between the surfaces of the click cams and those of the click protrusions when the user rotationally operates the rotating shaft of the rotational member. Even if force (tactile sensation) for stopping the rotation acts in the state having the rotational resistance, therefore, the tactile sensation may be hard to transmit to the user. In other words, it may be difficult for the user to obtain the tactile sensation.

### SUMMARY OF THE INVENTION

The present invention has been proposed in order to solve the aforementioned problem, and an object of the present invention is to provide a rotational input device and an electronic apparatus each capable of improving a tactile sensation provided to the user when the user rotationally operates a rotational operating portion.

A rotational input device according to a first aspect of the present invention includes a rotational operating portion rotationally operable by a user, a rotational position detecting portion arranged to overlap with the rotational operating portion in plan view for detecting a rotational position of the rotational operating portion, a magnetic force generating portion arranged to overlap with the rotational operating portion in plan view and a deflectable base portion arranged to overlap with the rotational operating portion in plan view in a state separated from the rotational operating portion at a prescribed interval, and is so formed that, when the rotational position detecting portion detects that the user has at least rotationally operated the rotational operating portion, the magnetic force generating portion is excited on the basis of the detected rotational position to generate magnetic force so that the base portion is sucked toward the rotational operating portion to be so deflected as to come into contact with the rotational operating portion thereby providing the user with a tactile sensation.

As hereinabove described, the rotational input device according to the first aspect of the present invention includes the deflectable base portion arranged to overlap with the rotational operating portion in plan view in the state separated from the rotational operating portion at the prescribed interval. Thus, the user can rotationally operate the rotational operating portion in a noncontact state where the rotational operating portion and the base portion are not in contact with each other dissimilarly to a case where the rotational operating portion and the base portion are arranged in a contact state, whereby no rotational resistance resulting from friction is caused between the rotational operating portion and the base portion. Consequently, the user can smoothly rotationally operate the rotational operating portion. Further, the rotational input device is so formed that, when the rotational position detecting portion detects that the user has at least rotationally operated the rotational operating portion, the magnetic force generating portion is excited on the basis of the detected rotational position to generate magnetic force so that the base portion is sucked toward the rotational operating portion to be so deflected as to come into contact with the rotational operating portion thereby providing the user with a tactile sensation. Thus, the rotational operating portion having been in the noncontact state allowing a smooth rotational operation thereof comes into contact with the base portion when the magnetic force generating portion is excited to generate magnetic force, whereby the rotational input device can provide the user with a clear tactile sensation when the rotational operating portion is switched from the noncontact state to the contact state. Consequently, the tactile sensation provided to the user can be improved dissimilarly to a case where the rotational operating portion and the base portion are regularly in contact with each other.

In the aforementioned rotational input device according to the first aspect, the base portion is preferably provided with a slit, to be deflectable. According to this structure, a part of the base portion located between the slit formed on the slit and another slit can be more easily deflected, dissimilarly to a case where the base portion is provided with no slit.

In this case, a plurality of slits are preferably formed on the base portion radially from a central portion toward an outer peripheral portion of the base portion in plan view, and preferably so formed that a magnetic field generated from the magnetic force generating portion easily passes through the plurality of slits. According to this structure, the base portion can be inhibited from blocking the magnetic field generated from the magnetic force generating portion.

In the aforementioned rotational input device having the plurality of slits formed on the base portion radially from the central portion toward the outer peripheral portion of the base portion, the slits are preferably formed on the base portion at equilateral intervals in plan view. According to this structure, parts of the base portion located between the slits formed on the base portion can be easily uniformly deflected along the overall base portion dissimilarly to a case where the slits formed on the base portion are not at equilateral intervals.

In the aforementioned rotational input device according to the first aspect, the rotational operating portion is preferably provided in the form of a disc having a circumferential edge portion projecting toward the base portion, the base portion is preferably flat-shaped, and the rotational input device is preferably so formed that, when the rotational position detecting portion detects that the user has at least rotationally operated the discoidal rotational operating portion having the edge portion, the magnetic force generating portion is excited on the basis of the detected rotational position to generate magnetic force so that the flat-shaped base portion is sucked toward the rotational operating portion and the outer peripheral portion of the flat-shaped base portion is deflected to come into contact with the edge portion of the discoidal rotational operating portion. According to this structure, the edge portion of the rotational operating portion and the outer peripheral portion of the base portion come into contact with each other from the ordinary noncontact state dissimilarly to a case where the edge portion of the rotational operating portion and the outer peripheral portion of the base portion are arranged in a contact state, whereby the rotational input device can provide the user with a clear tactile sensation when the edge portion of the rotational operating portion and the outer peripheral portion of the base portion are switched from the noncontact state to the contact state.

The aforementioned rotational input device according to the first aspect preferably further includes a pressure sensing portion sensing that the rotational operating portion has been pressed, and is preferably so formed that, when the pressure sensing portion senses that the user has pressed the rotational operating portion, the magnetic force generating portion is excited to generate magnetic force so that the base portion is sucked toward the rotational operating portion and so deflected as to come into contact with the rotational operating portion thereby providing the user with a tactile sensation, not only when the user has rotationally operated the rotational operating portion but also when he/she has pressed the rotational operating portion. According to this structure, the base portion collides with the rotational operating portion when the magnetic force generating portion is excited to generate magnetic fore, whereby the rotational input device can provide the user with a clear tactile sensation (such as that he/she gets when pressing a button) due to the collision of the base portion.

In the aforementioned rotational input device according to the first aspect, the rotational position detecting portion is preferably formed to output a signal responsive to the rotational position of the rotational operating portion, and the base portion is preferably provided with an opening for receiving a wire for transmitting the signal output from the rotational position detecting portion. According to this structure, the wire is so inserted into the opening of the base portion that the same can be prevented from being held between the base portion and the rotational operating portion when the base portion is deflected to come into contact with the rotational operating portion.

In the aforementioned rotational input device according to the first aspect, the rotational position detecting portion is preferably formed to detect the rotational position of the rotational operating portion by detecting a change in capacitance when the user has rotationally operated the rotational operating portion. According to this structure, the rotational position detecting portion can easily detect the rotational position of the rotational operating portion.

The aforementioned rotational input device according to the first aspect preferably further includes a bonding layer for fixing the inner peripheral side of the base portion to the magnetic force generating portion, and is preferably so formed that, when the user has rotationally operated the rotational operating portion and the magnetic force generating portion is excited to generate magnetic force, the base portion is so sucked toward the rotational operating portion that the outer peripheral side of the base portion is deflected along the bonding layer, serving as a fulcrum, provided on the inner peripheral side of the base portion to come into contact with the rotational operating portion. According to this structure, the outer peripheral portion of the base portion can be brought into contact with the rotational operating portion along the bonding layer, serving as a fulcrum, provided on the inner peripheral side of the base portion while the bonding layer inhibits the base portion from moving with respect to the magnetic force generating portion.

In the aforementioned rotational input device according to the first aspect, the magnetic force generating portion preferably includes an exciting coil, and at least the base portion is preferably made of a magnetic material and formed to function as a yoke in the rotational operating portion and the base portion. According to this structure, the base portion functioning as the yoke can strengthen magnetic force generated by the exciting coil, whereby the base portion can easily come into contact with the rotational operating portion.

An electronic apparatus according to a second aspect of the present invention includes a rotational input device including a rotational operating portion rotationally operable by a user, a rotational position detecting portion arranged to overlap with the rotational operating portion in plan view for detecting a rotational position of the rotational operating portion, a magnetic force generating portion arranged to overlap with the rotational operating portion in plan view and a deflectable base portion arranged to overlap with the rotational operating portion in plan view in a state separated from the rotational operating portion at a prescribed interval, and is so formed that, when the rotational position detecting portion detects that the user has at least rotationally operated the rotational operating portion, the magnetic force generating portion is excited on the basis of the detected rotational position to generate magnetic force so that the base portion is sucked toward the rotational operating portion to be so deflected as to come into contact with the rotational operating portion thereby providing the user with a tactile sensation.

As hereinabove described, the electronic apparatus according to the second aspect includes the rotational input device so formed that, when the rotational position detecting portion detects that the user has at least rotationally operated the rotational operating portion, the magnetic force generating portion is excited on the basis of the detected rotational position to generate magnetic force so that the base portion is sucked toward the rotational operating portion to be so deflected as to come into contact with the rotational operating portion thereby providing the user with a tactile sensation. Thus, the rotational operating portion having been in a noncontact state allowing a smooth rotational operation thereof comes into contact with the base portion when the magnetic force generating portion is excited to generate magnetic force, whereby the electronic apparatus can provide the user with a clear tactile sensation when the rotational operating portion is switched from the noncontact state to the contact state. Consequently, the electronic apparatus including the rotational input device can improve the tactile sensation provided to the user dissimilarly to a case where the rotational operating portion and the base portion are regularly in contact with each other.

In the aforementioned electronic apparatus according to the second aspect, the base portion is preferably provided with a slit, to be deflectable. According to this structure, a part of the base portion located between the slit formed on the slit and another slit can be more easily deflected, dissimilarly to a case where the base portion is provided with no slit.

In this case, a plurality of slits are preferably formed on the base portion radially from a central portion toward an outer peripheral portion of the base portion in plan view, and preferably so formed that a magnetic field generated from the magnetic force generating portion easily passes through the plurality of slits. According to this structure, the base portion can be inhibited from blocking the magnetic field generated from the magnetic force generating portion.

In the aforementioned electronic apparatus having the plurality of slits formed on the base portion radially from the central portion toward the outer peripheral portion of the base portion, the slits are preferably formed on the base portion at equilateral intervals in plan view. According to this structure, parts of the base portion located between the slits formed on the base portion can be easily uniformly deflected along the overall base portion dissimilarly to a case where the slits formed on the base portion are not at equilateral intervals.

In the aforementioned electronic apparatus according to the second aspect, the rotational operating portion is preferably provided in the form of a disc having a circumferential edge portion projecting toward the base portion, the base portion is preferably flat-shaped, and the electronic apparatus is so formed that, when the rotational position detecting portion detects that the user has at least rotationally operated the discoidal rotational operating portion having the edge portion, the magnetic force generating portion is excited on the basis of the detected rotational position to generate magnetic force so that the flat-shaped base portion is sucked toward the rotational operating portion and the outer peripheral portion of the flat-shaped base portion is deflected to come into contact with the edge portion of the discoidal rotational operating portion. According to this structure, the edge portion of the rotational operating portion and the outer peripheral portion of the base portion come into contact with each other from the ordinary noncontact state dissimilarly to a case where the edge portion of the rotational operating portion and the outer peripheral portion of the base portion are arranged in a contact state, whereby the electronic apparatus can provide the user with a clear tactile sensation when the edge portion of the rotational operating portion and the outer peripheral portion of the base portion are switched from the noncontact state to the contact state.

The aforementioned electronic apparatus according to the second aspect preferably further includes a pressure sensing portion sensing that the rotational operating portion has been pressed, and is preferably so formed that, when the pressure sensing portion senses that the user has pressed the rotational operating portion, the magnetic force generating portion is excited to generate magnetic force so that the base portion is sucked toward the rotational operating portion and so deflected as to come into contact with the rotational operating portion thereby providing the user with a tactile sensation, not only when the user has rotationally operated the rotational operating portion but also when he/she has pressed the rotational operating portion. According to this structure, the base portion collides with the rotational operating portion when the magnetic force generating portion is excited to generate magnetic fore, whereby the electronic apparatus can provide the user with a clear tactile sensation (such as that he/she gets when pressing a button) due to the collision of the base portion.

In the aforementioned electronic apparatus according to the second aspect, the rotational position detecting portion is preferably formed to output a signal responsive to the rotational position of the rotational operating portion, and the base portion is preferably provided with an opening for receiving a wire for transmitting the signal output from the rotational position detecting portion. According to this structure, the wire is so inserted into the opening of the base portion that the same can be prevented from being held between the base portion and the rotational operating portion when the base portion is deflected to come into contact with the rotational operating portion.

In the aforementioned electronic apparatus according to the second aspect, the rotational position detecting portion is preferably formed to detect the rotational position of the rotational operating portion by detecting a change in capacitance when the user has rotationally operated the rotational operating portion. According to this structure, the rotational position detecting portion can easily detect the rotational position of the rotational operating portion.

The aforementioned electronic apparatus according to the second aspect preferably further includes a bonding layer for fixing the inner peripheral side of the base portion to the magnetic force generating portion, and is preferably so formed that, when the user has rotationally operated the rotational operating portion and the magnetic force generating portion is excited to generate magnetic force, the base portion is so sucked toward the rotational operating portion that the outer peripheral side of the base portion is deflected along the bonding layer, serving as a fulcrum, provided on the inner peripheral side of the base portion to come into contact with the rotational operating portion. According to this structure, the outer peripheral portion of the base portion can be brought into contact with the rotational operating portion along the bonding layer, serving as a fulcrum, provided on the inner peripheral side of the base portion while the bonding layer inhibits the base portion from moving with respect to the magnetic force generating portion.

In the aforementioned electronic apparatus according to the second aspect, the magnetic force generating portion preferably includes an exciting coil, and at least the base portion is preferably made of a magnetic material and formed to function as a yoke in the rotational operating portion and the base portion. According to this structure, the base portion functioning as a yoke can strengthen magnetic force generated by the exciting coil, whereby the base portion can easily come into contact with the rotational operating portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing a portable telephone including a rotational input device according to an embodiment of the present invention;

FIG. 2 is a block diagram showing the portable telephone including the rotational input device according to the embodiment of the present invention;

FIG. 3 is a plan view of an operating body portion of the rotational input device according to the embodiment of the present invention;

FIG. 4 is a perspective view of the operating body portion of the rotational input device according to the embodiment of the present invention;

FIG. 5 is an exploded perspective view of the operating body portion of the rotational input device according to the embodiment of the present invention;

FIG. 6 is a plan view of a base portion of the operating body portion of the rotational input device according to the embodiment of the present invention;

FIG. 7 is a sectional view taken along the line 400-400 in FIG. 3;

FIG. 8 is a sectional view of the operating body portion of the rotational input device according to the embodiment of the present invention upon generation of magnetic force;

FIG. 9 is a sectional view of the operating body portion of the rotational input device according to the embodiment of the present invention in a pressed state; and

FIG. 10 a sectional view of the operating body portion of the rotational input device according to the embodiment of the present invention in a state so pressed that an exciting coil generates magnetic force.

### DESCRIPTION OF THE PREFERRED EMBODIMENTS

An embodiment of the present invention is now described with reference to the drawings.

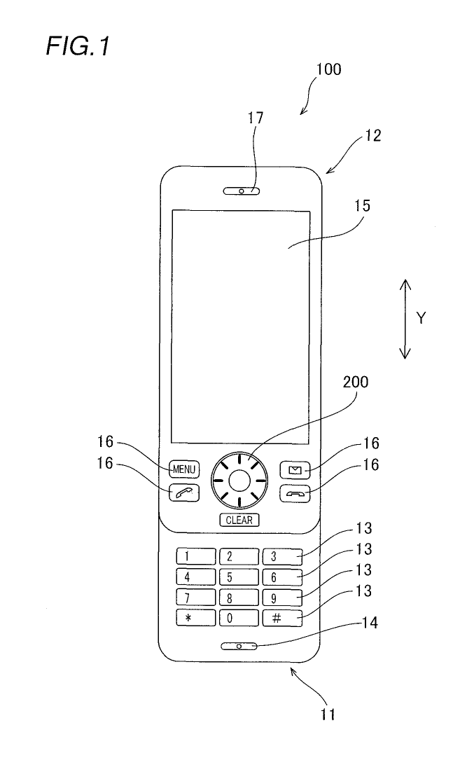

The structure of a portable telephone 100 including a rotational input device 200 according to the embodiment of the present invention is described with reference to FIGS. 1 to 7. The portable telephone 100 is an example of the “electronic apparatus” in the present invention.

As shown in FIG. 1, the portable telephone 100 according to the embodiment of the present invention includes an operating-side housing portion 11 having a rectangular shape in plan view and a display-side housing portion 12, having a rectangular shape, mounted on the upper surface of the operating-side housing portion 11 and slidable with respect to the operating-side housing portion 11 in a direction Y.

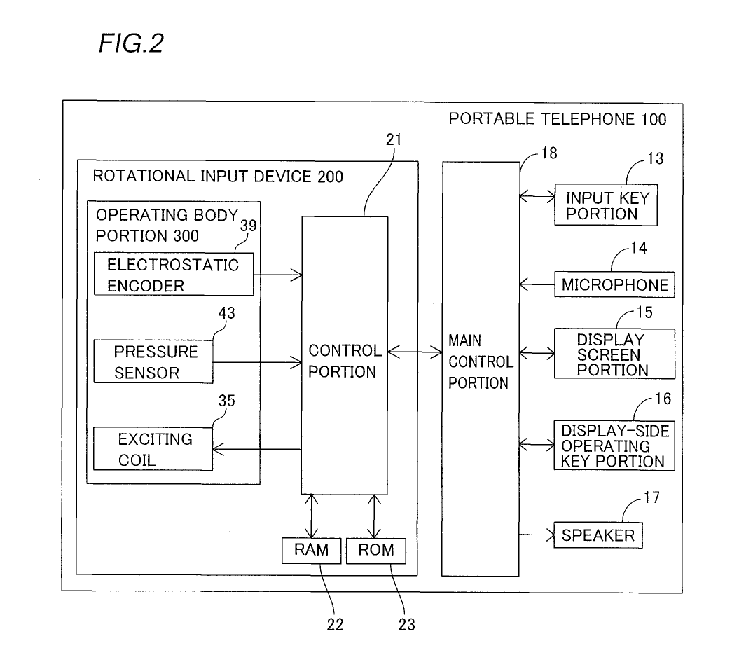

The operating-side housing portion 11 is provided with input key portions 13 of “0” to “9”, “*”, “#” and the like and a microphone 14. According to this embodiment, the display-side housing portion 12 is provided with the rotational input device 200, a display screen portion 15 consisting of a liquid crystal display, display-side operating key portions 16 including a menu button, a mail button and the like, a speaker 17 and a main control portion 18 controlling the portable telephone 100. The main control portion 18 is formed to be capable of transmitting/receiving signals to/from the input key portions 13, the microphone 14, the display screen portion 15, the display-side operating key portions 16 and the speaker 17, as shown in FIG. 2.

As shown in FIG. 2, the rotational input device 200 includes an operating body portion 300, a control portion 21 capable of transmitting/receiving signals to/from the operating body portion 300 and the main control portion 18, a RAM (random access memory) 22 for temporarily storing data and a ROM (read-only memory) 23 storing programs for controlling the operating body portion 300 and the like. The control portion 21 has a function of mainly controlling the rotational input device 200 for providing the user with an operating sensation or the like, dissimilarly to the main control portion 18 controlling the portable telephone 100.

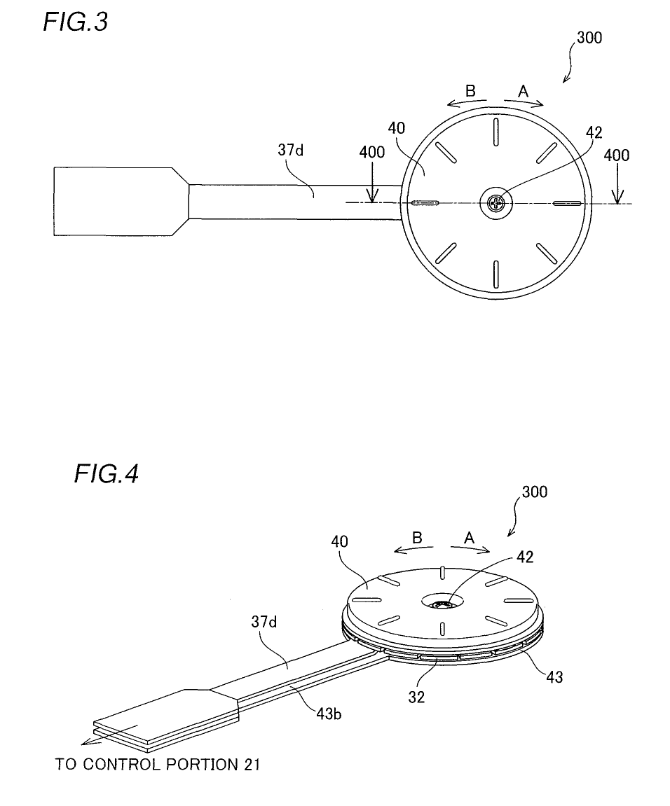

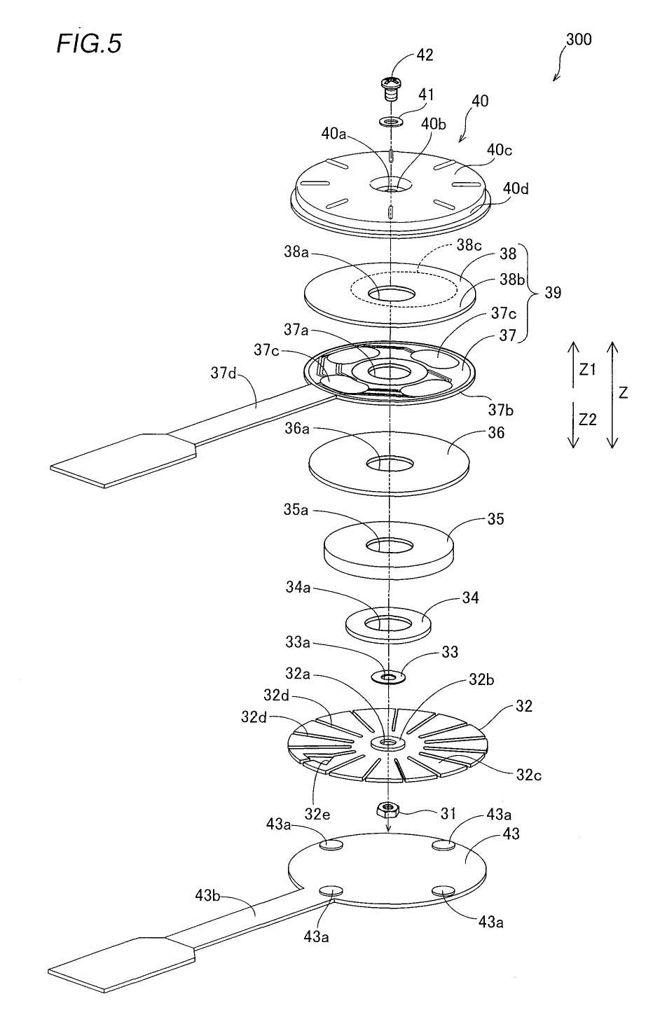

As shown in FIGS. 3 and 4, the operating body portion 300 has a substantially circular shape in plan view, and is formed to be rotatable by the user. As shown in FIG. 5, the operating body portion 300 includes a nut member 31, a base portion 32, a sliding member 33, a double-faced adhesive tape 34, an exciting coil 35, another double-faced adhesive tape 36, an electrostatic encoder 39 including a stator-side electrostatic encoder 37 and a rotor-side electrostatic encoder 38, a cap portion 40, a washer member 41 and a screw member 42. A pressure sensor 43 is arranged on a side of the base portion 32 along arrow Z2. The double-faced adhesive tape 34 is an example of the “bonding layer” in the present invention, and the exciting coil 35 is an example of the “magnetic force generating portion” in the present invention. The electrostatic encoder 39 is an example of the “rotational position detecting portion” in the present invention, and the cap portion 40 is an example of the “rotational operating portion” in the present invention. The pressure sensor 43 is an example of the “pressure sensing portion” in the present invention. The base portion 32, the sliding member 33, the double-faced adhesive tape 34, the exciting coil 35, the double-faced adhesive tape 36, the electrostatic encoder 39, the cap portion 40 and the washer member 41 are threaded together by the screw member 42 and the nut member 31, to be fixed to each other.

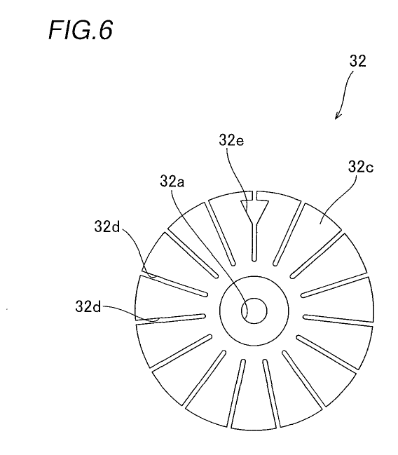

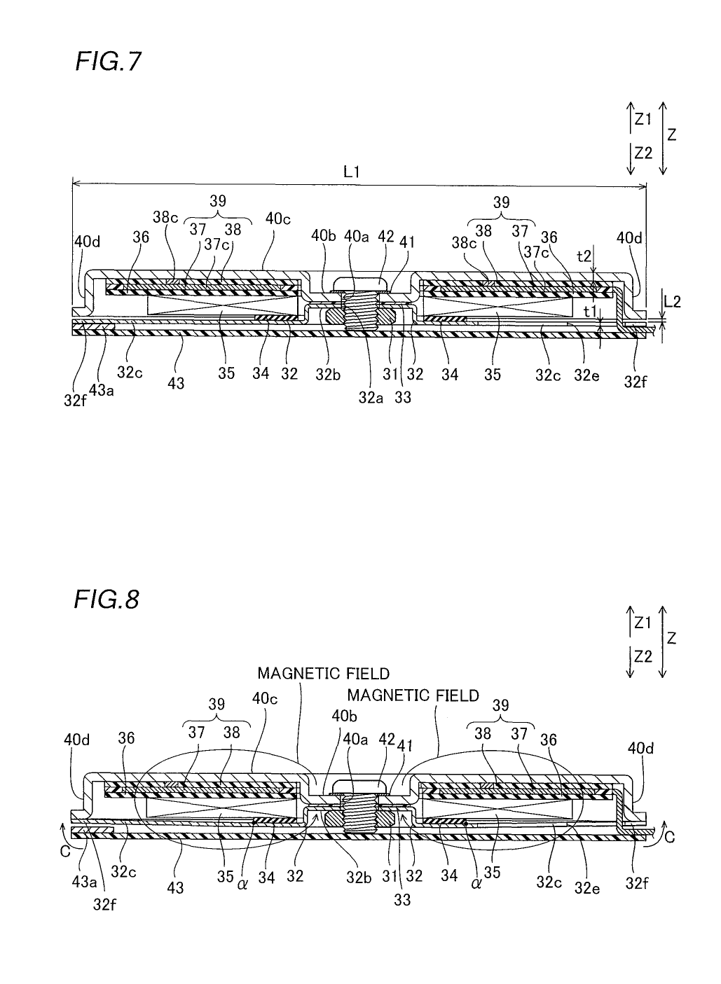

According to this embodiment, the base portion 32 has a discoidal shape in plan view, as shown in FIG. 6. An opening 32a capable of receiving the screw member 42 is formed on a central portion of the base portion 32. As shown in FIG. 7, the base portion 32 includes a projecting portion 32b, having a circular shape in plan view, provided on the inner peripheral side of the base portion 32 to project along arrow Z1 and a flat portion 32c provided on the outer peripheral side of the base portion 32. As shown in FIG. 6, 15 slits 32d are formed on the flat portion 32c of the base portion 32 radially from the opening 32a (central portion of the base portion 32) toward the outer peripheral side. The slits 32d are provided on the base portion 32 at equiangular intervals of about 24°. The slits 32d are so provided that parts of the base portion 32 located therebetween are deflectable similarly to plate springs. The base portion 32 is further provided with a substantially triangular opening 32e. The opening 32e is formed to be capable of receiving an FPC (flexible printed circuit board) 37d, described later, extending from the stator-side electrostatic encoder 37 (see FIG. 5). The base portion 32 is made of a magnetic material such as iron or SECC (electrolytic zinc-plated steel), and formed to function as a yoke. As shown in FIG. 7, the base portion 32 has a thickness t1 of about 0.2 mm.

As shown in FIG. 5, the sliding member 33 is arranged to overlap with the base portion 32 in plan view. The sliding member 33 has a ringlike discoidal shape. An opening 33a capable of receiving the screw member 42 is formed on a central portion of the sliding member 33. As shown in FIG. 7, the sliding member 33 is arranged to come into direct contact with the surface of the projecting portion 32b of the base portion 32 along arrow Z1. The sliding member 33 is so provided that the cap portion 40 is slidable with respect to the base portion 32. The sliding member 33 is formed to be slidable (rotatable) with respect to the base portion 32. The sliding member 33 is smaller in diameter than the projecting portion 32b of the base portion 32. The sliding member 33 is made of macromolecular polyethylene or silicone rubber.

As shown in FIG. 5, the double-faced adhesive tape 34 is arranged to overlap with the sliding member 33 in plan view. The double-faced adhesive tape 34 has a substantially discoidal shape. An opening 34a having a diameter larger than the outer diameter of the projecting portion 32b of the base portion 32 is formed on a central portion of the double-faced adhesive tape 34. As shown in FIG. 7, the double-faced adhesive tape 34 is directly stuck onto the inner peripheral surface of the flat portion 32c of the base portion 32 along arrow Z1.

As shown in FIG. 5, the exciting coil 35 is arranged to overlap with the double-faced adhesive tape 34 in plan view. The exciting coil 35 has a substantially discoidal shape. An opening 35a having a diameter larger than the outer diameter of the projecting portion 32b of the base portion 32 is formed on a central portion of the exciting coil 35. The exciting coil 35 is formed by winding a conductor. As shown in FIG. 7, the surface of the exciting coil 35 along arrow Z2 is stuck to the surface of the double-faced adhesive tape 34 along arrow Z1. Thus, the exciting coil 35 is fixed to the inner peripheral side (closer to the opening 32a) of the base portion 32. The exciting coil 35 is formed to generate magnetic force in response to a voltage input from the control portion 21 (see FIG. 2). The exciting coil 35 is formed to be excited every prescribed rotational angle of the cap portion 40, and formed to alternately repeat a state (ordinary state) where the exciting coil 35 is not excited to generate no magnetic force and a state where the exciting coil 35 is excited to generate magnetic force.

As shown in FIG. 5, the double-faced adhesive tape 36 is arranged to overlap with the exciting coil 35 in plan view. The double-faced adhesive tape 36 has a substantially discoidal shape. An opening 36a having a diameter larger than the outer diameter of a projecting portion 40b, described later, of the cap portion 40 is formed on a central portion of the double-faced adhesive tape 36. As shown in FIG. 7, the double-faced adhesive tape 36 is directly stuck onto the surface of the exciting coil 35 along arrow Z1.

As shown in FIG. 5, the stator-side electrostatic encoder 37 is arranged to overlap with the double-faced adhesive tape 36 in plan view. The stator-side electrostatic encoder 37 has a substantially discoidal shape. An opening 37a having a diameter larger than the outer diameter of the projecting portion 40b, described later, of the cap portion 40 is formed on a central portion of the stator-side electrostatic encoder 37. The stator-side electrostatic encoder 37 includes a filmlike substrate 37b, four electrode portions 37c provided on the surface of the substrate 37b along arrow Z1 and the insulating zonal FPC 37d for transmitting a signal to the control portion 21. As shown in FIG. 7, the stator-side electrostatic encoder 37 is directly stuck onto the surface of the double-faced adhesive tape 36 along arrow Z1. Thus, the stator-side electrostatic encoder 37 is fixed to the exciting coil 35 and the base portion 32 by the double-faced adhesive tape 36. The FPC 37d extending from the stator-side electrostatic encoder 37 is drawn out from the opening 32e formed on the base portion 32.

As shown in FIG. 5, the rotor-side electrostatic encoder 38 is arranged to overlap with the stator-side electrostatic encoder 37 in plan view. The rotor-side electrostatic encoder 38 has a substantially discoidal shape. An opening 38a having a diameter larger than the outer diameter of the projecting portion 40b, described later, of the cap portion 40 is formed on a central portion of the rotor-side electrostatic encoder 38. The rotor-side electrostatic encoder 38 includes a filmlike substrate 38b and a circular electrode portion 38c provided on the surface of the substrate 38b along arrow Z2. The circular electrode portion 38c is provided to be eccentric to the center (opening 38a) of the rotor-side electrostatic encoder 38. The outer diameter of the rotor-side electrostatic encoder 38 is substantially equal to that of the stator-side electrostatic encoder 37. The rotor-side electrostatic encoder 38 is formed to be rotatably movable with respect to the stator-side electrostatic encoder 37. The rotational input device 200 is formed to detect a change in capacitance between the electrode portions 38c and 37c resulting from movement of the electrode portion 38c provided on the rotor-side electrostatic encoder 38 with respect to the electrode portion 37c of the stator-side electrostatic encoder 37.

According to this embodiment, the cap portion 40 is arranged to overlap with the rotor-side electrostatic encoder 38 in plan view, as shown in FIG. 5. The cap portion 40 has a substantially discoidal shape, as shown in FIG. 5. An opening 40a capable of receiving the screw member 42 is formed on a central portion of the cap portion 40. As shown in FIG. 7, the cap portion 40 has the projecting portion 40b provided on the inner peripheral side of the cap portion 40 to project along arrow Z2, a flat portion 40c provided on the outer peripheral side of the cap portion 40 and an edge portion 40d, having a flange-shaped portion, provided on the outer peripheral side of the flat portion 40c to project along arrow Z2. The cap portion 40 has a diameter L1 of about 27 mm.

The surface of the projecting portion 40b of the cap portion 40 along arrow Z2 is arranged to be in contact with the surface of the sliding member 33 along arrow Z1. Thus, the cap portion 40 is formed to be rotationally movable with respect to the sliding member 33. The rotor-side electrostatic encoder 38 is stuck to the surface of the flat portion 40c along arrow Z2 with a double-faced adhesive tape (not shown) or the like. The cap portion 40 is made of a magnetic material such as iron or SECC (electrolytic zinc-plated steel), and formed to function as a yoke. The cap portion 40 has a thickness t2 of about 0.5 mm. In the state (ordinary state) where the exciting coil 35 does not generate magnetic force, the surface of the edge portion 40d of the cap portion 40 along arrow Z2 and the surface of an outer peripheral portion 32f of the flat portion 32c of the base portion 32 along arrow Z1 are arranged at an interval L2 of about 0.05 mm.

As shown in FIG. 5, the pressure sensor 43 is arranged to overlap with the base portion 32 in plan view. The pressure sensor 43 includes four sensor portions 43a provided at intervals of about 90° and an FPC 43b for transmitting a signal to the control portion 21 (see FIG. 2) when the user presses any of the sensor portions 43a. The pressure sensor 43 is formed to detect pressing of the cap portion 40 when the user presses the cap portion 40 along arrow Z2.

A rotational operation of the cap portion 40 of the operating body portion 300 of the rotational input device 200 according to the embodiment of the present invention is described with reference to FIGS. 2, 3, 7 and 8.

When the user rotationally operates the cap portion 40 in a direction A or B as shown in FIG. 3, the electrostatic encoder 39 detects the rotational position of the cap portion 40. More specifically, the rotor-side electrostatic encoder 38 rotates with the cap portion 40 shown in FIG. 7 when the user rotationally operates the cap portion 40 in the direction A or B. Thus, the electrode portion 38c provided on the rotor-side electrostatic encoder 38 rotationally moves with respect to the four electrode portions 37c provided on the stator-side electrostatic encoder 37. At this time, the electrode portion 38c provided on the rotor-side electrostatic encoder 38 and the four electrode portions 37c provided on the stator-side electrostatic encoder 37 relatively move, thereby changing the capacitance between the electrode portions 38c and 37c. Then, the electrostatic encoder 39 outputs the change in the capacitance to the control portion 21 as an electric signal, as shown in FIG. 2. If determining that the cap portion 40 is not located on a prescribed rotational position (at the prescribed rotational angle) on the basis of the output electric signal (rotational position) at this time, the control portion 21 enters the state (ordinary state) not exciting the exciting coil 35. Thus, the exciting coil 35 generates no magnetic force at this time. Then, the surface of the edge portion 40d of the cap portion 40 along arrow Z2 and the surface of the outer peripheral portion 32f of the base portion 32 along arrow Z1 are arranged in a noncontact state at the interval L2 of about 0.05 mm, as shown in FIG. 7. At this time, the user is not provided with a tactile sensation but can smoothly rotationally operate the cap portion 40.

If determining that the cap portion 40 is located on the prescribed rotational position (at the prescribed rotational angle) on the basis of the electric signal (rotational position) output from the electrostatic encoder 39 when the user further rotationally operates the cap portion 40 in the direction A or B as shown in FIG. 3, the control portion 21 excites the exciting coil 35. If the user rotates the cap portion 40 at about 2 rpm, the control portion 21 excites the exciting coil 35 for about 250 ms. If the user rotationally operates the cap portion 40 at a rotational frequency faster than about 2 rpm, the control portion 21 may excite the exciting coil 35 for a shorter period.

When the exciting coil 35 is excited to generate magnetic force as shown in FIG. 8, the cap portion 40 and the base portion 32 function as yokes, whereby the magnetic force generated by the exciting coil 35 can be strengthened. The base portion 32 is so sucked along arrow C that parts of the outer peripheral portion 32f of the base portion 32 located between the slits 32d are deflected along an end portion of the double-faced adhesive tape 34 serving as a fulcrum α. Consequently, the surfaces of the deflected parts of the outer peripheral portion 32f of the base portion 32 along arrow Z1 come into contact with the surface of the edge portion 40d of the cap portion 40 along arrow Z2, to provide the user with a sensation (braking sensation) for stopping the rotational operation of the cap portion 40.

If determining that the cap portion 40 is not located on the prescribed rotational position (at the prescribed rotational angle) on the basis of the electric signal (rotational position) output from the electrostatic encoder 39 when the user thereafter further rotationally operates the cap portion 40 in the direction A or B, the control portion 21 enters the state (ordinary state) not exciting the exciting coil 35. Then, the surface of the edge portion 40d of the cap portion 40 along arrow Z2 and the surface of the outer peripheral portion 32f of the base portion 32 along arrow Z1 return to the noncontact state separated from each other at the interval L2 of about 0.05 mm, as shown in FIG. 7. At this time, the user is not provided with a tactile sensation but can smoothly rotationally operate the cap portion 40.

An operation of pressing the cap portion 40 of the operating body portion 300 of the rotational input device 200 according to the embodiment of the present invention is described with reference to FIGS. 2, 9 and 10.

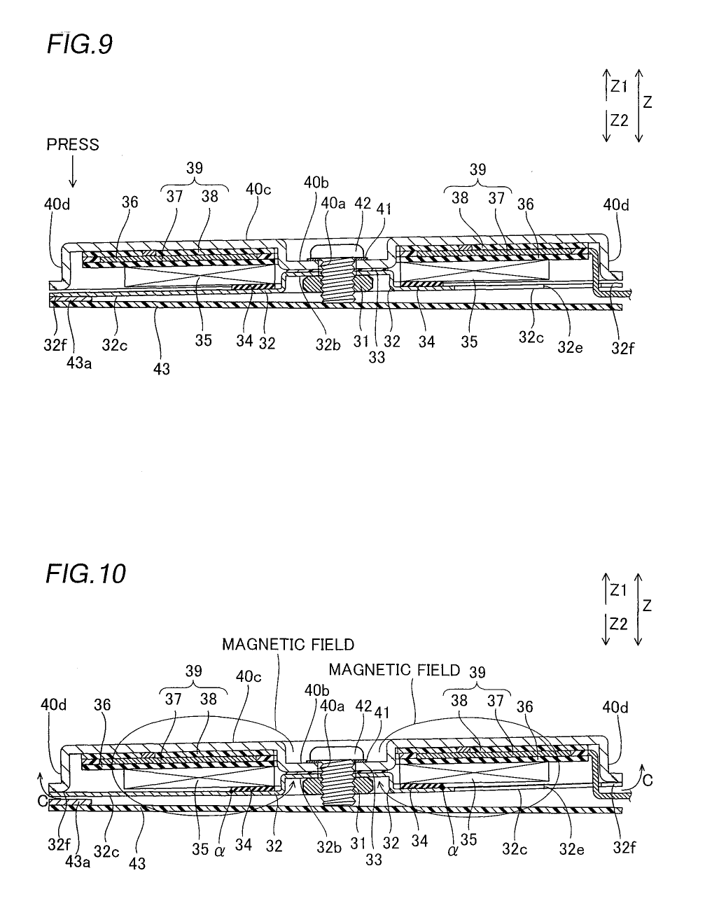

When the user presses a portion in the vicinity of the outer periphery of the cap portion 40, a portion of the base portion 32 located on a side of the portion pressed by the user along arrow Z2 comes into contact with the corresponding sensor portion 43a, as shown in FIG. 9. Thus, the pressure sensor 43 shown in FIG. 2 outputs a signal to the control portion 21. Then, the control portion 21 excites the exciting coil 35, which in turn generates magnetic force. The control portion 21 excites the exciting coil 35 for about 10 ms.

When the exciting coil 35 is excited to generate magnetic force, the cap portion 40 and the base portion 32 are magnetized by magnetic fields (magnetic force) generated by the exciting coil 35. Thus, the base portion 32 is so sucked along arrow C that the parts of the outer peripheral portion 32f of the base portion 32 located between the slits 32d are deflected along the end portion of the double-faced adhesive tape 34 serving as a fulcrum α, as shown in FIG. 10. Consequently, the surfaces of the deflected parts of the outer peripheral portion 32f of the base portion 32 along arrow Z1 collide with the surface of the edge portion 40d of the cap portion 40 along arrow Z2. The rotational input device 200 provides the user with a tactile sensation (buttony sensation) as a result of this collision.

When the user stops pressing the operating body portion 300 and the control portion 21 stops exciting the exciting coil 35, the exciting coil 35 stops generating magnetic force, and the surface of the outer peripheral portion 32f of the base portion 32 along arrow Z1 separates from the surface of the edge portion 40d of the cap portion 40 along arrow Z2. Then, the surface of the edge portion 40d of the cap portion 40 along arrow Z2 and the surface of the outer peripheral portion 32f of the base portion 32 along arrow Z1 are separated from each other at the interval L2 of about 0.05 mm, as shown in FIG. 7.

According to this embodiment, as hereinabove described, the rotational input device 200 includes the deflectable base portion 32 arranged to overlap with the cap portion 40 in plan view in a state separated from the cap portion 40 at the interval of about 0.2 mm. Thus, the user can rotationally operate the cap portion 40 in the noncontact state where the cap portion 40 and the base portion 32 are not in contact with each other dissimilarly to a case where the cap portion 40 and the base portion 32 are arranged in contact with each other, whereby no rotational resistance resulting from friction is caused between the cap portion 40 and the base portion 32. Consequently, the user can smoothly rotationally operate the cap portion 40. Further, the rotational input device 200 is so formed that the base portion 32 is sucked toward the cap portion 40 and deflected to come into contact (collide) with the cap portion 40 thereby providing the user with a tactile sensation when the electrostatic encoder 39 detects that the user has rotationally operated the cap portion 40 and the control portion 21 excites the exciting coil 35 on the basis of the detected rotational position and the exciting coil 35 generates magnetic force. Thus, the cap portion 40 having been in the noncontact state allowing a smooth rotational operation thereof comes into contact with the base portion 32 when the exciting coil 35 is excited to generate magnetic force, whereby the rotational input device 200 can provide the user with a clear tactile sensation when the cap portion 40 is switched from the noncontact state to the contact state. Consequently, the tactile sensation provided to the user can be improved dissimilarly to a case where the cap portion 40 and the base portion 32 are regularly in contact with each other.

According to this embodiment, as hereinabove described, the base portion 32 is provided with the slits 32d to be deflectable, whereby the parts of the base portion 32 located between the slits 32d formed on the base portion 32 can be easily deflected dissimilarly to a case where no slits 32d are formed on the base portion 32.

According to this embodiment, as hereinabove described, the rotational input device 200 is so formed that the magnetic fields generated by the exciting coil 35 easily pass through the 15 slits 32d, whereby the base portion 32 can be inhibited from blocking the magnetic fields generated by the exciting coil 35.

According to this embodiment, as hereinabove described, the slits 32d are formed on the base portion 32 at the equiangular intervals of about 24° in plan view, whereby the parts of the base portion 32 located between the slits 32d can be uniformly deflected along the overall base portion 32 dissimilarly to a case where the slits 32d formed on the base portion 32 are not at the equiangular intervals.

According to this embodiment, as hereinabove described, the outer peripheral portion 32f of the flat base portion 32 is deflected to come into contact with the edge portion 40d of the discoidal cap portion 40 so that the edge portion 40d of the cap portion 40 and the outer peripheral portion 32f of the base portion 32 come into contact with each other from the ordinary noncontact state dissimilarly to a case where the edge portion 40d of the cap portion 40 and the outer peripheral portion 32f of the base portion 32 are arranged in a contact state, whereby the rotational input device 200 can provide the user with a clear tactile sensation when the edge portion 40d of the cap portion 40 and the outer peripheral portion 32f of the base portion 32 are switched from the noncontact state to the contact state.

According to this embodiment, as hereinabove described, the exciting coil 35 is excited to generate magnetic force when the pressure sensor 43 senses that the user has pressed the cap portion 40 so that the base portion 32 is sucked toward the cap portion 40 and collides with the cap portion 40 when the exciting coil 35 is excited to generate magnetic force, whereby the rotational input device 200 can provide the user with a clear tactile sensation (such as that he/she gets when pressing a button) due to the collision of the base portion 32.

According to this embodiment, as hereinabove described, the base portion 32 is provided with the opening 32e for receiving the FPC 37d for transmitting the signal output from the electrostatic encoder 39, whereby the FPC 37d is so inserted into the opening 32e of the base portion 32 that the same can be prevented from being held between the base portion 32 and the cap portion 40 when the base portion 32 is deflected to come into contact with the cap portion 40.

According to this embodiment, as hereinabove described, the electrostatic encoder 39 detects the rotational position of the cap portion 40 by detecting change in the capacitance when the user rotationally operates the cap portion 40, whereby the rotational position of the cap portion 40 can be easily detected.

According to this embodiment, as hereinabove described, the parts of the outer peripheral portion 32f of the base portion 32 located between the slits 32d are deflected along the end portion, serving as a fulcrum α, of the double-faced adhesive tape 34 provided on the inner peripheral side of the base portion 32 to come into contact with the cap portion 40, whereby the parts of the outer peripheral portion 32f of the base portion 32 located between the slits 32d can be brought into contact with the cap portion 40 along the end portion, serving as a fulcrum α, of the double-faced adhesive tape 34 provided on the inner peripheral side of the base portion 32 while the double-faced adhesive tape 34 inhibits the base portion 32 from moving with respect to the exciting coil 35.

According to this embodiment, as hereinabove described, the cap portion 40 and the base portion 32 are made of the magnetic materials and formed to function as yokes so that the base portion 32 functioning as a yoke can strengthen the magnetic force generated by the exciting coil 35, whereby the base portion 32 can easily come into contact with the cap portion 40.

Although the present invention has been described and illustrated in detail, it is clearly understood that the same is by way of illustration and example only and is not to be taken by way of limitation, the spirit and scope of the present invention being limited only by the terms of the appended claims.

For example, while the portable telephone is employed as an example of the electronic apparatus in the aforementioned embodiment, the present invention is not restricted to this. The present invention is also applicable to another electronic apparatus such as a PDA, a portable game machine or a microwave oven, for example, so far as the same has a rotational operating portion.

While the exciting coil is employed as an example of the magnetic force generating portion in the aforementioned embodiment, the present invention is not restricted to this. The magnetic force generating portion may alternatively be formed by an element other than the exciting coil, so far as the same can generate magnetic force in response to the rotational position detected by the rotational position detecting portion.

While the base portion is made of iron or SECC (electrolytic zinc-plated steel) in the aforementioned embodiment, the present invention is not restricted to this. The base portion may alternatively be made of a magnetic material other than iron or SECC (electrolytic zinc-plated steel) so far as the base portion can be sucked toward the cap portion when the exciting coil generates magnetic force, for example.

While the base portion is provided with the 15 slits in the aforementioned embodiment, the present invention is not restricted to this. The base portion may alternatively be provided with at least 16 slits, for example. In this case, the parts of the base portion located between the slits can be more easily deflected, and the magnetic fields generated by the exciting coil can more easily pass through the slits. Further alternatively, the base portion may be provided with less than 15 slits.

While the base portion is so formed that the parts located between the slits are deflected in the aforementioned embodiment, the present invention is not restricted to this. The base portion may alternatively be provided with no slits so far as the same is deflectable by magnetic force, for example.

While the base portion is provided with the substantially triangular opening for receiving the FPC for transmitting the signal output from the electrostatic encoder in the aforementioned embodiment, the present invention is not restricted to this. The base portion may alternatively be provided with a substantially quadrangular opening or a substantially circular opening, for example.

While the slits are formed on the base portion radially from the central portion toward the outer peripheral portion of the base portion in the aforementioned embodiment, the present invention is not restricted to this. The slits of the base portion may alternatively be spirally shaped in plan view, for example.

While the double-faced adhesive tape is employed as an example of the bonding layer for fixing the inner peripheral side of the base portion to the exciting coil in the aforementioned embodiment, the present invention is not restricted to this. The inner peripheral side of the base portion may alternatively be fixed to the exciting coil with an adhesive or the like, so far as the adhesive or the like can fix the inner peripheral side of the base portion to the exciting coil, for example.

While the electrostatic encoder is employed as an example of the rotational position detecting portion in the aforementioned embodiment, the present invention is not restricted to this. The rotational position detecting portion may alternatively be formed by a mechanical encoder or an optical encoder, for example.

What is claimed is:

1. A rotational input device comprising:
a rotational operating portion rotationally operable by a user;
a rotational position detecting portion arranged to overlap with said rotational operating portion in plan view for detecting a rotational position of said rotational operating portion;
a magnetic force generating portion arranged to overlap with said rotational operating portion in plan view; and
a deflectable base portion arranged to overlap with said rotational operating portion in plan view in a state separated from said rotational operating portion at a prescribed interval, and
so formed that, when said rotational position detecting portion detects that said user has at least rotationally operated said rotational operating portion, said magnetic force generating portion is excited on the basis of detected said rotational position to generate magnetic force so that said base portion is sucked toward said rotational operating portion to be so deflected as to come into contact with said rotational operating portion thereby providing said user with a tactile sensation.

2. The rotational input device according to claim 1, wherein
said base portion is provided with a slit, to be deflectable.

3. The rotational input device according to claim 2, wherein
a plurality of said slits are formed on said base portion radially from a central portion toward an outer peripheral portion of said base portion in plan view, and
so formed that a magnetic field generated from said magnetic force generating portion easily passes through said plurality of slits.

4. The rotational input device according to claim 3, wherein
said slits are formed on said base portion at equilateral intervals in plan view.

5. The rotational input device according to claim 1, wherein
said rotational operating portion is provided in the form of a disc having a circumferential edge portion projecting toward said base portion,
said base portion is flat-shaped, and
the rotational input device is so formed that, when said rotational position detecting portion detects that said user has at least rotationally operated said discoidal rotational operating portion having said edge portion, said magnetic force generating portion is excited on the basis of detected said rotational position to generate magnetic force so that said flat-shaped base portion is sucked toward said rotational operating portion and said outer peripheral portion of said flat-shaped base portion is deflected to come into contact with said edge portion of said discoidal rotational operating portion.

6. The rotational input device according to claim 1, further comprising a pressure sensing portion sensing that said rotational operating portion has been pressed, and
so formed that, when said pressure sensing portion senses that said user has pressed said rotational operating portion, said magnetic force generating portion is excited to generate magnetic force so that said base portion is sucked toward said rotational operating portion and so deflected as to come into contact with said rotational operating portion thereby providing said user with a tactile sensation, not only when said user has rotationally operated said rotational operating portion but also when he/she has pressed said rotational operating portion.

7. The rotational input device according to claim 1, wherein
said rotational position detecting portion is formed to output a signal responsive to said rotational position of said rotational operating portion, and
said base portion is provided with an opening for receiving a wire for transmitting said signal output from said rotational position detecting portion.

8. The rotational input device according to claim 1, wherein
said rotational position detecting portion is formed to detect said rotational position of said rotational operating portion by detecting a change in capacitance when said user has rotationally operated said rotational operating portion.

9. The rotational input device according to claim 1, further comprising a bonding layer for fixing the inner peripheral side of said base portion to said magnetic force generating portion, and
so formed that, when said user has rotationally operated said rotational operating portion and said magnetic force generating portion is excited to generate magnetic force, said base portion is so sucked toward said rotational operating portion that the outer peripheral side of said base portion is deflected along said bonding layer, serving as a fulcrum, provided on the inner peripheral side of said base portion to come into contact with said rotational operating portion.

10. The rotational input device according to claim 1, wherein
said magnetic force generating portion includes an exciting coil, and
at least said base portion is made of a magnetic material and formed to function as a yoke in said rotational operating portion and said base portion.

11. An electronic apparatus comprising a rotational input device including a rotational operating portion rotationally operable by a user, a rotational position detecting portion arranged to overlap with said rotational operating portion in plan view for detecting a rotational position of said rotational operating portion, a magnetic force generating portion arranged to overlap with said rotational operating portion in plan view and a deflectable base portion arranged to overlap with said rotational operating portion in plan view in a state separated from said rotational operating portion at a prescribed interval, and so formed that, when said rotational position detecting portion detects that said user has at least rotationally operated said rotational operating portion, said magnetic force generating portion is excited on the basis of detected said rotational position to generate magnetic force so that said base portion is sucked toward said rotational operating portion to be so deflected as to come into contact with said rotational operating portion thereby providing said user with a tactile sensation.

12. The electronic apparatus according to claim 11, wherein
said base portion is provided with a slit, to be deflectable.

13. The electronic apparatus according to claim 12, wherein
a plurality of said slits are formed on said base portion radially from a central portion toward an outer peripheral portion of said base portion in plan view, and
so formed that a magnetic field generated from said magnetic force generating portion easily passes through said plurality of slits.

14. The electronic apparatus according to claim 13, wherein
said slits are formed on said base portion at equilateral intervals in plan view.

15. The electronic apparatus according to claim 11, wherein
said rotational operating portion is provided in the form of a disc having a circumferential edge portion projecting toward said base portion,
said base portion is flat-shaped, and
the electronic apparatus is so formed that, when said rotational position detecting portion detects that said user has at least rotationally operated said discoidal rotational operating portion having said edge portion, said magnetic force generating portion is excited on the basis of detected said rotational position to generate magnetic force so that said flat-shaped base portion is sucked toward said rotational operating portion and said outer peripheral portion of said flat-shaped base portion is deflected to come into contact with said edge portion of said discoidal rotational operating portion.

16. The electronic apparatus according to claim 11, further comprising a pressure sensing portion sensing that said rotational operating portion has been pressed, and
so formed that, when said pressure sensing portion senses that said user has pressed said rotational operating portion, said magnetic force generating portion is excited to generate magnetic force so that said base portion is sucked toward said rotational operating portion and so deflected as to come into contact with said rotational operating portion thereby providing said user with a tactile sensation, not only when said user has rotationally operated said rotational operating portion but also when he/she has pressed said rotational operating portion.

17. The electronic apparatus according to claim 11, wherein
said rotational position detecting portion is formed to output a signal responsive to said rotational position of said rotational operating portion, and
said base portion is provided with an opening for receiving a wire for transmitting said signal output from said rotational position detecting portion.

18. The electronic apparatus according to claim 11, wherein
said rotational position detecting portion is formed to detect said rotational position of said rotational operating portion by detecting a change in capacitance when said user has rotationally operated said rotational operating portion.

19. The electronic apparatus according to claim 11, further comprising a bonding layer for fixing the inner peripheral side of said base portion to said magnetic force generating portion, and
so formed that, when said user has rotationally operated said rotational operating portion and said magnetic force generating portion is excited to generate magnetic force, said base portion is so sucked toward said rotational operating portion that the outer peripheral side of said base portion is deflected along said bonding layer, serving as a fulcrum, provided on the inner peripheral side of said base portion to come into contact with said rotational operating portion.

20. The electronic apparatus according to claim 11, wherein
said magnetic force generating portion includes an exciting coil, and
at least said base portion is made of a magnetic material and formed to function as a yoke in said rotational operating portion and said base portion.
